(19) United States
(12) Patent Application Publication
(10) Pub. No.: US 2008/0274738 A1
(43) Pub. Date: Nov. 6, 2008

(54) Method For Communication Between A Wlan Radio Station And A Base Station Of A Cellular Radio Communications System, And Corresponding Radio Station And Base Station

(76) Inventors: Hui Li, Beijing (CN); Dan Yu, Beijing (CN)

Correspondence Address: STAAS & HALSEY LLP, SUITE 700, 1201 NEW YORK AVENUE, N.W., WASHINGTON, DC, 20005, US

(21) Appl. No.: 11/547,430

(22) PCT Filed: Feb. 16, 2005
(86) PCT No.: PCT/EP2005/050691

§ 371 Date: Sep. 29, 2006

(30) Foreign Application Priority Data
Mar. 31, 2004 (DE) 10 2004 015 894.0

(51) Int. Cl. H04Q 7/20; H04M 1/00

(52) U.S. Cl. 455/435.1; 455/561

(57) ABSTRACT

A radio facility receives a request, which is made by a first radio station and which is routed by a second radio station to the radio facility, regarding a future sending of a message from the first radio station to a third radio station. In addition, the radio facility sends, to at least one or to each radio station of a path, which extends over one or more radio stations and via which the message can be transmitted from the first radio station to the third radio station by routing it through radio stations of the path, information concerning the radio station adjacent to the respective radio station of the path along said path in the direction of the third radio station and, optionally, also information concerning radio resources to be used in the event of a routing of the message through the respective radio station of the path. A radio facility and a radio station carry out said method.

### CROSS REFERENCE TO RELATED APPLICATIONS

This application is based on and hereby claims priority to PCT/EP2005/050691 filed on Feb. 16, 2005 and German priority application No. 10 2004 015 894.0 filed on Mar. 31, 2004, the contents of which are hereby incorporated by reference.

### BACKGROUND

The invention relates to a method for communicating by radio between a radio facility and radio stations, and a radio facility and a radio station for implementing the method.

In radio communications systems messages (for example voice, image information, video information, SMS (Short Message Service), MMS (Multimedia Messaging Service) or other data are transmitted with the aid of electromagnetic waves by way of a radio interface between the sending and receiving stations. Depending on the specific configuration of the radio communications system, the stations can be different types of subscriber-side radio stations, repeaters, radio access points or network-side radio facilities, such as base stations. In a mobile radio communications system at least some of the subscriber-side radio stations are mobile radio stations. The electromagnetic waves are emitted at carrier frequencies, which are within the frequency band provided for the respective system.

Mobile radio communications systems are frequently configured as cellular systems, for example according to the GSM (Global System for Mobile Communication) or UMTS (Universal Mobile Telecommunications System) standards with a network infrastructure comprising for example base stations, facilities for monitoring and controlling the base stations and further network-side facilities.

In addition to these extensive (supralocal) cellular hierarchical radio networks, there are also wireless local networks (WLANs, Wireless Local Area Networks) with a generally much more spatially restricted radio coverage area. The cells covered by the radio access points (AP: Access Point) of the WLANs have a diameter of up to several hundred meters, making them small compared with the standard mobile radio cells. Examples of different standards for WLANs are HiperLAN, DECT, IEEE 802.11, Bluetooth and WATM.

The unlicensed frequency range around 2.4 GHz is generally used for WLANs. Data transmission speeds are around up to 11 Mbit/s. It will be possible to operate future WLANs in the 5 GHz range, achieving data speeds of more than 50 Mbit/s. WLAN subscribers will therefore have data speeds, which are significantly faster than those provided by the third mobile radio generation (e.g. UMTS). Access to WLANs for high bit-rate connections is therefore advantageous for transmitting large quantities of data, in particular in conjunction with internet access.

WLAN radio access points can be used to interface with other communications systems, e.g. broadband data networks BDN. To this end the WLAN radio stations communicate either directly with a radio access point or in the case or more remote radio stations by way of other radio stations, which forward the information between the radio station and the radio access point by way of a path between the radio station and the radio access point.

If there are two different radio communications systems, such as for example a WLAN and a cellular system, at the same point, it is possible that there are both radio stations present, which can communication within both radio communications systems, and radio stations, which can communicate solely within either the one or the other radio communications system. Where a WLAN coexists with a cellular system, radio stations can for example be present, which have both a WLAN and a cellular radio interface, as can radio stations, which only have one or more WLAN-compatible radio interfaces.

### SUMMARY OF THE INVENTION

One possible object of the invention is to demonstrate an efficient method for communicating by radio, which can in particular also be used when radio stations with differently equipped radio interfaces are present. A radio facility and a radio station, which can support the implementation of the method, are also to be proposed.

The inventors propose a method for communicating by radio between a radio facility and radio stations, the radio facility receives a request from a first radio station forwarded by a second radio station to the radio facility relating to the future sending of a message from the first radio station to a third radio station. The radio facility also sends information to at least one radio station on a path extending by way of one or more radio stations between the first radio station and the third radio station, said information relating to the radio station adjacent to the respective radio station on the path along said path in the direction of the third radio station. The message can hereby be transmitted from the first radio station to the third radio station by being forwarded by the radio stations on the path.

The path is defined by the radio facility and/or by a facility connected to the radio facility using information about adjacency relations between radio stations. If the two groups of radio stations described in more detail below are present, the adjacency relations may in particular only relate to radio stations of the second group or those radio stations, which communicate with the radio facility according to the second radio standard. The information about adjacency relations between radio stations is preferably determined by radio stations and sent to the radio facility.

The radio stations on a path are those radio stations, which forward a message from a sender to a recipient. As far as the path between the first and third radio stations is concerned, about which the radio facility sends signaling information to the radio stations on the path, it is advantageous if the second radio station is a radio station on this path.

The first radio station sends a request, which is forwarded by the second radio station to the radio facility, which can for example be configured as a base station of a cellular radio communications system. Such forwarding is particularly advantageous, if the first radio station cannot communicate in a direct manner with the radio facility, such that communication between the first radio station and the radio facility operates by way of the second radio station. The request states or implies that the first radio station wishes or intends to send a message and optionally also that a path between the first and third radio stations or the allocation of radio resources to send the message and preferably also to forward the message are to be determined and notified in an appropriate manner.

It is advantageous if the request also contains details of the source and destination radio stations for the message, as well as the size of the message to be sent. The radio facility sends out path information on receipt of the request.

In one preferred embodiment said information allows complete transmission of the message from the second to the third radio station.

In a development the radio facility sends information to at least one radio station on the path about the radio resources to be used during the forwarding of the message by the respective radio station on the path. The resource allocation information allows uninterrupted transmission of the message from the first to the third radio station, without collisions resulting due to the assignment of radio resources, which is for example possible, if the radio stations on the path are not allocated any resources for forwarding. If both the path information and the resource allocation information are only sent to some of the radio stations on the path, it is advantageous if these two different types of information are sent to the same radio stations on the path.

In one refinement the radio facility sends the path information or path information and resource allocation information to every radio station on the path. In this instance the information does not have to be passed between radio stations for the efficient transmission of the message from the first to the third radio station by way of the path.

In a development the first radio station belongs to a first group of radio stations, the radio interface or radio interfaces of which are different from the radio interface for communication between radio stations and the radio facility. The radio stations on the path also belong to a second group of radio stations, the radio interfaces of which include a radio interface for communication with the radio facility. Communication by radio is then only possible, if the characteristic radio interface for the respective communication is present, for example a radio interface for communicating within a WLAN or within GSM or UMTS or even for communicating on a specific frequency band within a system. Direct communication between the first radio station and the radio facility is therefore not possible, while the radio stations on the path can communicate with the radio facility due to the configuration of their radio interface. The third radio station preferably also belongs to the second group. The first group can for example be mobile subscriber stations, the second group radio stations that are of fixed location or stationary at least some of the time and can serve as relay stations between mobile subscriber stations and radio access points.

Different radio interfaces can for example differ based on the radio standards used for communication by way of the respective radio interface. It is advantageous if communication between radio stations takes place using a first radio standard, for example according to a WLAN standard, and communication between radio stations and the radio facility takes place using a second radio standard that is different from the first, for example according to the GSM or UMTS standard.

According to a development the radio facility sends information to the second radio station about radio resources to be used by the first radio station when sending the message. The second radio station can then forward this information to the first radio station. This procedure is particularly advantageous, if the first radio station cannot communicate directly with the radio facility due to the configuration of its radio interface.

According to one refinement the first radio station sends the message to the second radio station and each radio station on the path routes the message to the respective adjacent radio station along the path in the direction of the third radio station. Such transmission of the message from the first radio station by way of the path to the third radio station preferably takes place using the radio resources signaled beforehand by the radio facility.

In a development the radio facility sends the third radio station and/or at least some of the radio stations on the path information about the radio station adjacent to the respective radio station along the path in the direction of the first radio station. In the event that the information is sent for example not only to some of the radio stations on a path, of which the second radio station is part, but to all the radio stations on this path, the information notifies the second radio station that a message to the first radio station is to be forwarded directly to the first radio station by the second radio station.

The radio facility has the following for communicating by radio with radio stations: a receiver to receive a request from a first radio station forwarded by a second radio station to the radio facility relating to the future sending of a message from the first radio station to a third radio station, a definition unit to define a path using information about adjacency relations between radio stations and a transmitter to send information to at least one radio station on the path extending by way of one or more radio stations, by way of which the message can be transmitted from the first radio station to the third radio station by being forwarded by the radio stations on the path, said information relating to the radio station adjacent to the respective radio station on the path along said path in the direction of the third radio station.

The radio facility is particularly advantageous, if the two groups of radio stations described above are present or if the radio stations as described above communicate using two different radio standards.

In a development the radio facility also has sends information about radio resources to be used, when the respective radio station on the path forwards the message to at least radio station on the path.

According to a preferred refinement the radio facility sends the information to every radio station on the path.

In a development the radio facility also has sends information to the second radio station about radio resources to be used by the first radio station when sending the message.

The radio station has the following for communicating by radio with radio stations and a radio facility:

a receiver to receive a request sent by a first further radio station relating to the future sending of a message from the first further radio station to a second further radio station, a transmitter to forward the request from the first further radio station to the radio facility. The radio station receives information about radio resources to be used by the first further radio station when sending the message from the radio station. The radio station forwards the information about the resources to be used by the first further radio station when sending the message to the first further radio station.

The first further radio station can in particular belong to the first group of radio stations described above and the radio station and the second further radio station to the second group described above. The radio station is preferably a mobile radio station and/or a subscriber-side radio station. It is possible for the radio station to communicate with the first further radio station using a first radio standard and with the radio facility using a second radio standard that is different from the first.

In a development, the radio station also receives information about a third further radio station from the radio facility, to which third further radio station the message from the first further radio station to the second further radio station is to be forwarded by the radio station. The radio station may also receive information about the radio resources to be used during forwarding by the radio facility are also provided.

The radio facility and the radio station are particularly suitable for implementing the method, the refinements and developments being equally so.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1: a section of two radio communications systems,

FIG. 2: a first schematic diagram of the progress over time of a method according to one possible embodiment of the invention,

FIG. 3: a second schematic diagram of the progress over time of a method according to one possible embodiment of the invention,

FIG. 4: a schematic diagram of the structure of a base station according to one possible embodiment of the invention, and

FIG. 5: a schematic diagram of the structure of a radio station according to one possible embodiment of the invention.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

Although reference is made in the exemplary embodiment below to a cellular mobile radio communications system and a WLAN, the method can also be used in other radio communications systems.

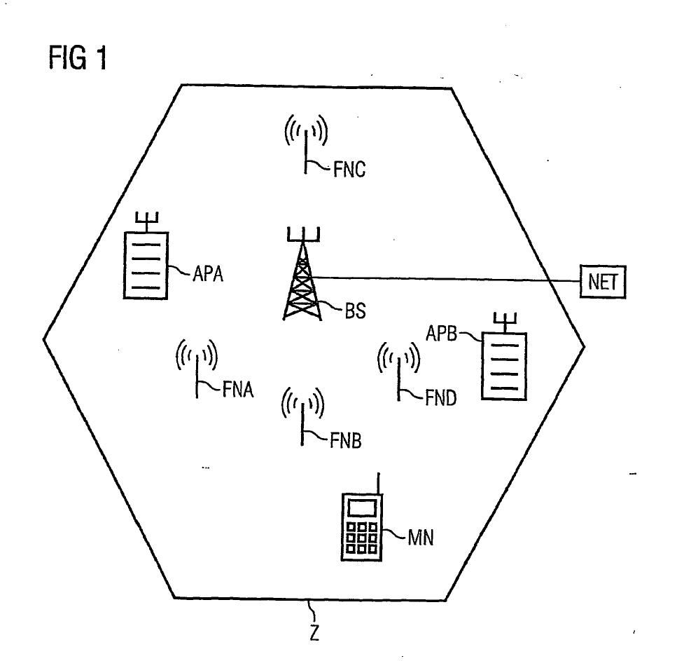

FIG. 1 shows a radio cell Z of a base station BS of a cellular radio communications system. The base station BS, being a component of the radio access network of the cellular radio communications system, is connected to further infrastructure facilities NET, for example a facility for managing the radio resources of one or more base stations and a core network. Further base stations of the cellular radio communications system and their respective radio cells are not shown in FIG. 1 for the sake of clarity.

The two radio access points APA and APB of a WLAN, which allow interfacing with other communications systems, in particular the internet, are located in the radio cell Z. Further components of the WLAN are the radio stations FNA, FNB, FNC and FND, which serve to forward messages between the mobile station MN and the radio access points APA and APB. Such forwarding is advantageous, as communication within the WLAN takes place in a high frequency range with a low level of transmit power, such that the radio coverage area of the radio access points APA and APB is extremely limited. The radio stations FNA, FNB, FNC and FND can be fixed-location or stationary radio stations, such as for example permanently installed repeaters, or even mobile stations, which temporarily take on the function of forwarding messages between mobile stations and radio access points. The method can also be used, when the mobile station MN is a fixed-location radio station.

The radio stations FNA, FNB, FNC and FND, the radio access points APA and APB and the mobile station MN have a radio interface that is characteristic of the WLAN, such that they can communicate directly with each other. The radio stations FNA, FNB, FNC and FND, the radio access points APA and APB and the mobile station MN use a WLAN standard to communicate with each other. While the mobile station MN only has the WLAN radio interface, the radio stations FNA, FNB, FNC and FND and the radio access points APA and APB also have a radio interface that is characteristic of the cellular radio communications system. The radio stations FNA, FNB, FNC and FND and the radio access points APA and APB can thus communicate both with each other and with the mobile station MN as well as with the base station BS of the of the cellular radio communications system. A mobile standard of a cellular radio communications system is used for communicating with the base station BS. In contrast the mobile station MN is unable to communicate directly with the base station BS, as it does not have the radio interface required for this purpose.

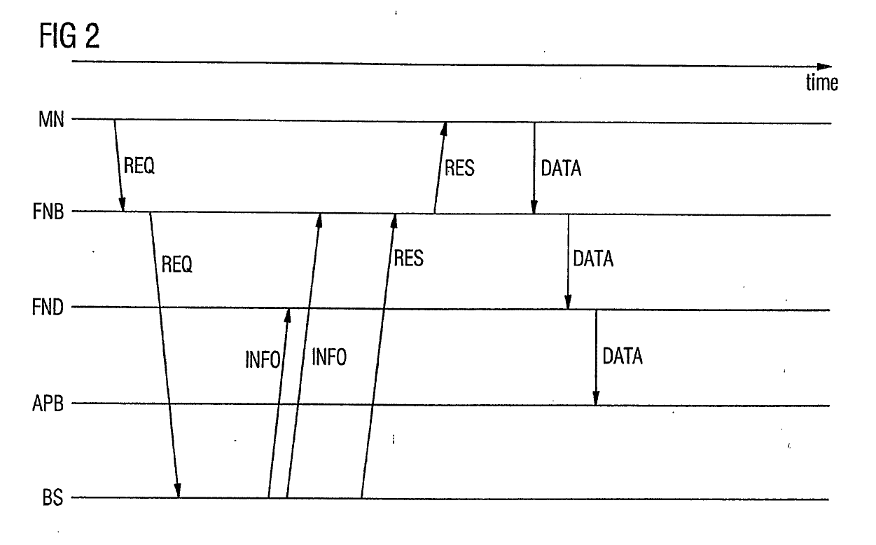

Let us look now at the instance where the mobile station MN wishes to send a message to a radio access point, to request data from the internet. FIG. 2 shows the progress over time of a method, the time being plotted to the right. The mobile station MN sends a request REQ to its adjacent radio station FNB, with which it notifies the radio station FNB that it wishes to send a message of a defined volume, as specified in the request REQ, to a radio access point. The mobile station MN does not have to specify the radio access point APA or APB with which it wishes to communicate here. The radio station FNB forwards the request REQ to the base station BS.

On receipt of the request REQ, the base station BS or a suitable network-side facility of the cellular radio communications system connected to the base station BS defines a path between the mobile station MN and one of the radio access points APA or APB, the path extending solely by way of the radio stations FNA, FNB, FNC and FND. Further mobile stations in the vicinity of the mobile station MN and the radio access points APA and APB may not be used to forward messages between the mobile station MN and the radio access points APA and APB.

In order to define a suitable path between the mobile station MN and a radio access point APA or APB, the base station BS or the network-side facility of the cellular radio communications system connected to the base station BS knows the adjacency relations between the radio stations FNA, FNB, FNC and FND and the radio access points APA and APB. To this end the radio stations FNA, FNB, FNC and FND and the radio access point APA and APB have sounded out their respective neighbors unit by a suitable signaling exchange and sent the result to the base station BS. Two radio stations or a radio station and a radio access point are neighbors or adjacent when a message can be transmitted directly between them, without the message having to be forwarded. The path can be defined in the base station BS or in the network side facility connected to the base station BS using methods that are known per se.

It is assumed below that it has been determined on the network side that the message is to be sent from the mobile station MN to the radio access point APB, the message having to be forwarded by the radio stations FNB and FND to this end. The radio stations on the path between the mobile station MN and the radio access point APB are therefore the two radio stations FNB and FND. The base station BS sends information INFO to the two radio stations FNB and FND respectively about the adjacent radio station, to which the message is to be forwarded, and about the radio resources to be used for forwarding purposes. The information INFO for the radio station FNB can thus be as follows: the next neighbor in the direction of the radio access point APB is the radio station FND, a frequency F1 and a time slot Z1 are to be used to forward a message from the mobile station MN to the radio access point APB. The information INFO for the radio station FND can correspondingly be as follows: the next neighbor in the direction of the radio access point APB is the radio access point APB, a frequency F1 and a time slot Z2 are to be used to forward a message from the mobile station MN to the radio access point APB. Other radio resources can also be signaled using the information INFO, depending on the configuration of the radio communications system, in which the method is used.

The base station BS also sends the radio station FNB, which communicates directly with the mobile station MN, information RES about the radio resources the mobile station MN is to use to send the message to the radio station FNB. This information RES is forwarded from the radio station FNB to the mobile station MN.

Once both the radio stations FNB and FND and also the mobile station MN know which radio resources are to be used to send or forward the message from the mobile station MN to the radio access point APB, and the neighbors, to which the message is to be forwarded, the mobile station MN sends the message DATA to the radio station FNB. The message DATA is then forwarded first from the radio station FNB to the radio station FND and then from the radio station FND to the radio access point APB. To this end the mobile station MN and the two radio stations FNB and FND use the radio resources signaled to them respectively by the base station BS.

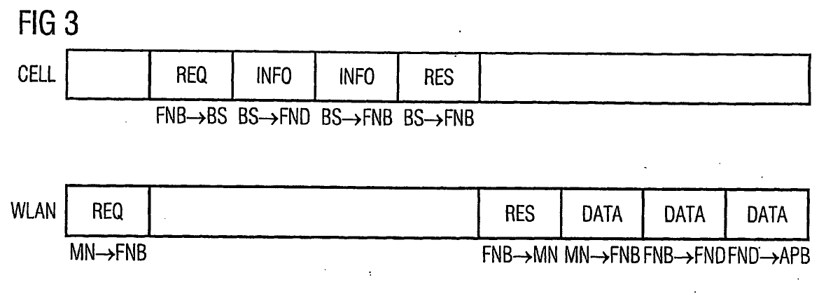

FIG. 3 shows an overview of the radio interfaces used to transmit the described messages or information. The upper bar CELL here represents a transmission by way of the radio interface that is characteristic of the cellular radio communications system, while the lower bar WLAN symbolizes the radio interface that is characteristic of the WLAN. It is specified below the respective message or information, which stations are senders or recipients of the message or information.

At the start the request REQ is sent by way of the WLAN radio interface WLAN from the mobile radio station MN to the radio station FNB, which forwards the request REQ by way of the cellular radio interface CELL to the base station BS. The information INFO and RES is sent from the base station BS to the radio station FND or FNB by way of the cellular radio interface CELL. The information RES is forwarded from the radio station FNB to the mobile station MN using the WLAN radio interface WLAN, with the message DATA being subsequently transmitted from the mobile station MN by way of the two radio stations FNB and FND to the radio access point APB via the same WLAN radio interface WLAN.

The path and resource allocation information INFO can also only be sent from the base station BS to some of the radio stations on the path. If the information INFO is only sent to the radio station FNB for example, the radio station FNB can forward the information relating to the radio station FND to the radio station FND.

As an alternative to the above procedure, the information sent by the base station BS can also relate solely to the path information, such that radio stations on the path only receive information about their adjacent radio station on the side of the radio access point. The method for allocating radio resources can then be implemented in a decentralized manner, in other words without involving the base station BS.

It is possible for the base station BS also to notify the radio stations FND and FNB and the radio access point APB of the neighbors, to which a message from the radio access point APB to the mobile station MN is to be sent or forwarded. The radio station FND is therefore signaled to the radio access point APB, the radio station FNB to the radio station FND and the mobile station MN to the radio station FNB. It is also possible to allocate radio resources for the transmission of messages from the radio access point APB to the mobile station MN in addition to the allocation of radio resources for the transmission of messages from the mobile station MN to the radio access point APB. This information can then be used on receipt of the message DATA by the radio access point APB for a transmission of internet content to the mobile station MN.

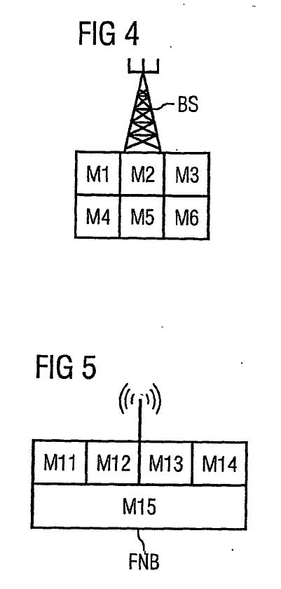

FIG. 4 shows a schematic diagram of the structure of a base station BS with the units M1 to M6. The base station BS can use the unit M1 to receive and evaluate a request from the mobile station MN forwarded to it from the radio station FNB. The unit M2 allow the base station BS to send path information about the respective neighbor in the direction of the radio access point APB to the radio stations FNB and FND or at least to some of the radio stations on the path between the mobile station MN and the radio access point APB. The unit M3 are used to send information about radio resources to be used during the forwarding of messages between the mobile station MN and the radio access point APB to the radio stations FNB and/or FND. The unit M4 allow the described information to be sent from the base station BS to both radio stations FNB and FND. The unit M5 allow the base station BS to send information to the radio station FNB with information about radio resources to be used by the mobile station MN when the message is being sent. Finally the unit M6 are used to define the path between the mobile station MN and the radio access point APB.

FIG. 5 shows a schematic diagram of the structure of an radio station FNB with the units M11 to M15. The radio station FNB uses the unit M11 to receive and process the request from the mobile station MN relating to the planned sending of a message to the radio access point APB, which it can forward to the base station BS using the unit M12. The unit M13 are used to receive information from the base station BS relating to the radio resources to be used by the mobile station MN. The radio station FNB forwards this information to the mobile station MN using the unit M14. The unit M15 are used to receive information from the base station BS by way of the radio station FND, to which the radio station FNB has to forward a message from the mobile station MN to the radio access point APB.

The implementation of both the base station BS according to FIG. 4 and the radio station FNB according to FIG. 5 is equivalent to a number of interconnected facilities, which have the corresponding unit.

A description has been provided with particular reference to preferred embodiments thereof and examples, but it will be understood that variations and modifications can be effected within the spirit and scope of the claims which may include the phrase “at least one of A, B and C” as an alternative expression that means unit one or more of A, B and C may be used, contrary to the holding in Superguide v. DIRECTV, 358 F3d 870, 69 USPQ2d 1865 (Fed. Cir. 2004).

1-16. (canceled)

17. A method for communicating by radio between a radio facility and radio stations, comprising:
receiving a request from a first radio station that was forwarded to a second radio station and received at the radio facility from the second radio station, the request relating to a data message that will be sent in the future from the first radio station to a third radio station;
sending a setup message from the radio facility to at least one intermediate radio station on a path extending from the first radio station to the third radio station so that the intermediate radio station can forward the data message and the data message can be transmitted via the intermediate radio station on the path, the setup message containing information about a radio station adjacent to the intermediate radio station on the path from the first radio station to the third radio station, in the direction of the third radio station; and
defining the path by the radio facility and/or by a facility connected to the radio facility using information about adjacency relations between radio stations.

18. The method as claimed in claim 17, wherein the radio facility sends to the intermediate radio station information about radio resources which are to be used when the intermediate radio station forwards the data message.

19. The method as claimed in claim 17, wherein the radio facility sends the information about radio resources to every radio station on the path.

20. The method as claimed in claim 17, wherein the radio facility sends the setup message to every radio station on the path.

21. The method as claimed in claim 17, wherein communication of the data message between radio stations takes place using a first radio standard and communication between radio stations and the radio facility takes place using a second radio standard that is different from the first radio standard.

22. The method as claimed in claim 17, wherein the first radio station belongs to a first group of radio stations, which uses a first radio interface or radio interfaces which is different from a second radio interface used for communication with the radio facility, and the intermediate radio station belongs to a second group of radio stations which use the second radio interface.

23. The method as claimed in claim 17, wherein the radio facility sends information to the second radio station about radio resources to be used by the first radio station when sending the data message.

24. The method as claimed in claim 23, wherein
the second radio station forwards to the first radio station the information about the radio resources to be used by the first radio station when the first radio station sends the data message.

25. The method as claimed claim 17, wherein the information about adjacency relations between radio stations is determined by the radio stations and forwarded to the radio facility.

26. The method as claimed in claim 17, wherein
there are a plurality of intermediate radio stations,
the second radio station is one of the intermediate radio stations,
the first radio station sends the data message to the second radio station, and
each intermediate radio station on the path forwards the data message to the respective adjacent radio station along the path in the direction of the third radio station.

27. The method as claimed in claim 17, wherein
a return path is defined from the third radio station to the first radio using a plurality of intermediate radio stations,
the radio facility sends the third radio station and/or at least two intermediate radio stations on the return path information about the radio station adjacent to the respective radio station along the return path in the direction of the first radio station.

28. The method as claimed in claim 18, wherein
the radio facility sends the information about radio resources to every radio station on the path.

29. The method as claimed in claim 28,
wherein communication of the data message between radio stations takes place using a first radio standard and communication between radio stations and the radio facility takes place using a second radio standard that is different from the first radio standard.

30. The method as claimed in claim 29, wherein
a second radio interface is used for communication between the intermediate radio station and the radio facility,
the first radio station uses a first radio interface different from the second radio interface, and
the first radio station does not have a capability to use the second interface.

31. The method as claimed in claim 30, wherein the radio facility sends information to the second radio station about radio resources to be used by the first radio station when sending the data message.

32. A radio facility for communicating by radio, comprising:
a receiver to receive a request from a first radio station that was forwarded from the first radio station to a second radio station and from the second radio station to the radio facility, the message relating to a data message that will be sent in the future from the first radio station to a third radio station;
a definition unit to define a path on which the data message is to be sent, the path being defined using information about adjacency relations between radio stations, the path being from the first radio station to the third radio station via at least one intermediate radio station;
a transmitter to send a setup message to at least one intermediate radio station on the path extending from the first radio station to the third radio station, the setup message containing information about a radio station adjacent to the intermediate radio station on the path in the direction of the third radio station.

33. The radio facility as claimed in claim 32, wherein the setup message contains information about radio resources to be used when the intermediate radio station forwards the data message to an adjacent radio station.

34. The radio facility as claimed in claim 32, wherein a setup message is sent to every radio station on the path.

35. The radio facility as claimed in claim 32, wherein the radio facility sends information to the second radio station about radio resources to be used by the first radio station when the first radio station sends the data message.

36. A radio station for communicating by radio with radio stations and a radio facility, comprising:
a receiver to receive a request sent by an originator radio station relating to a future sending of a data message from the originator radio station to a destination radio station via an intermediate radio station; and
a transmitter to forward the request to the radio facility, wherein
the receiver receives information from the radio facility about radio resources to be used by the originator radio station when the originator radio station sends the data message, and
the transmitter forwards to the originator radio station the information about the radio resources to be used by the originator radio station when the originator radio station sends the data message.

37. The radio station as claimed in claim 36, wherein
the receiver receives the data message from the originator radio station, the transmitter forwards the data message to the intermediate radio station, and the intermediate radio station forwards the data message toward the destination radio station,
the receiver receives from the radio facility information identifying the intermediate radio station, to which transmitter forwards the data message.
